(19) United States
(12) Patent Application Publication
(10) Pub. No.: US 2024/0271008 A1
(43) Pub. Date: Aug. 15, 2024

(54) Anisotropic Stretch Release Tape

(71) Applicants: Cheng CHEN, Redmond, WA (US); J. Shelton LEWIS, Redmond, WA (US); Microsoft Technology Licensing, LLC, Redmond, WA (US)

(72) Inventors: Cheng CHEN, Shanghai City (CN); J. Shelton LEWIS, Redmond, WA (US)

(73) Assignee: Microsoft Technology Licensing, LLC, Redmond, WA (US)

(21) Appl. No.: 18/565,036

(22) PCT Filed: May 28, 2022
(86) PCT No.: PCT/CN2021/096657

§ 371 Date: Nov. 28, 2023

(51) Int. Cl. C09J 7/20

(52) U.S. Cl. CPC C09J 7/203; C09J 2203/326; C09J 2301/1242; C09J 2301/20; C09J 2301/302; C09J 2301/308; C09J 2301/312

(57) ABSTRACT

A computing system includes a computing component connected to a housing with an anisotropic stretch release tape. The anisotropic stretch release tape includes a backing having an upper surface and a lower surface. The upper surface includes an upper PSA layer and the lower surface includes a lower PSA layer. The anisotropic stretch release tape includes a first removal force in a first direction that is at least 50% less than a second removal force in a second direction.

### BACKGROUND

Modern trends in computing devices include smaller, thinner, and lighter computing devices. Computing devices include many components that are connected to each other and/or a housing. Adhesives are often used to connect two computing devices to reduce weight and/or the thickness of the computing device. Adhesives may be removable to allow for the repair and/or replacement of the computing device.

### BRIEF SUMMARY

In some embodiments, a stretch release tape includes a backing including an upper and a lower surface. The backing is deformable. A first pressure sensitive adhesive (PSA) layer is connected to the upper surface and a second PSA layer is connected to the lower surface. A first removal force for the stretch release tape in a first direction is 50 percent less than a second removal force in a second direction.

In some embodiments, the first PSA layer includes a plurality of grooves. Each groove has a groove width of between 25 micrometers and 2,000 micrometers. In some embodiments, the first PSA layer is connected to a computing component and the lower PSA layer is connected to a housing.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a schematic representation of a computing device, according to at least one embodiment of the present disclosure;

FIG. 2-1 is a representation of an anisotropic stretch release tape connected to a computing component and a housing, according to at least one embodiment of the present disclosure;

FIG. 2-2 is a representation of the anisotropic stretch release tape of FIG. 2-1 disconnected from the computing component and the housing;

FIG. 3 is a representation of another anisotropic stretch release tape connected to a computing component and a housing, according to at least one embodiment of the present disclosure:

FIG. 4 is a representation of yet another anisotropic stretch release tape connected to a computing component and a housing, according to at least one embodiment of the present disclosure;

FIG. 5 is a representation of still another anisotropic stretch release tape connected to a computing component and a housing, according to at least one embodiment of the present disclosure:

FIG. 6 is a representation of a further anisotropic stretch release tape connected to a computing component and a housing, according to at least one embodiment of the present disclosure;

FIG. 7 is a representation of a manufacturing system for an anisotropic stretch release tape, according to a least one embodiment of the present disclosure; and

FIG. 8 is a flowchart of a method for manufacturing an anisotropic stretch release tape, according to at least one embodiment of the present disclosure.

### DETAILED DESCRIPTION

This disclosure generally relates to devices, systems, and methods for an anisotropic stretch release tape that allows for the clean separation of two computing components. The anisotropic stretch release tape includes a backing with a pressure sensitive adhesive (PSA) layer on both sides of the backing. At least one of the PSA layers includes a grooved surface that is formed using a gravure roller. The PSA layer having the grooved surface has a removal force in a first direction that is at least 50% a removal force in a second direction. This may help the anisotropic stretch release tape to be removed without leaving a residue behind on the surface from which it is removed and without breaking the backing of the stretch release tape. This may improve the ease with which computing components are removed and/or replaced on a computing device.

Modern computing devices include many different components that are assembled in a housing. Such components may include a battery, one or more processors, one or more heat sinks, one or more antennas, a touch screen display, any other computing component, and combinations thereof. In some computing devices, one or more computing components may be connected to the housing or another computing component using a double-sided tape. A double-sided tape may include a backing having an upper surface and a lower surface. A PSA may be deposited on both the upper surface and the lower surface. The upper surface may be applied to the computing component and the lower surface may be applied to the housing. This may secure the computing component to the housing. Modern trends in computing devices are for smaller, thinner, and lighter computing devices, often associated with the same or higher levels of performance. The double-sided tape between a computing component and the housing may increase the thickness of the computing device or reduce the amount of space that could be used by the computing component.

In accordance with embodiments of the present disclosure, the anisotropic stretch release tape may be manufactured using a gravure roller. This may allow for the total thickness of the anisotropic stretch release tape (e.g., the combined thickness of both PSA layers and the backing) to be reduced. In some embodiments, the total thickness of the anisotropic stretch release tape may be less than 250 micrometers or less than 100 micrometers. Reducing the thickness of the stretch release tape may help to reduce the overall thickness and/or weight of a computing device.

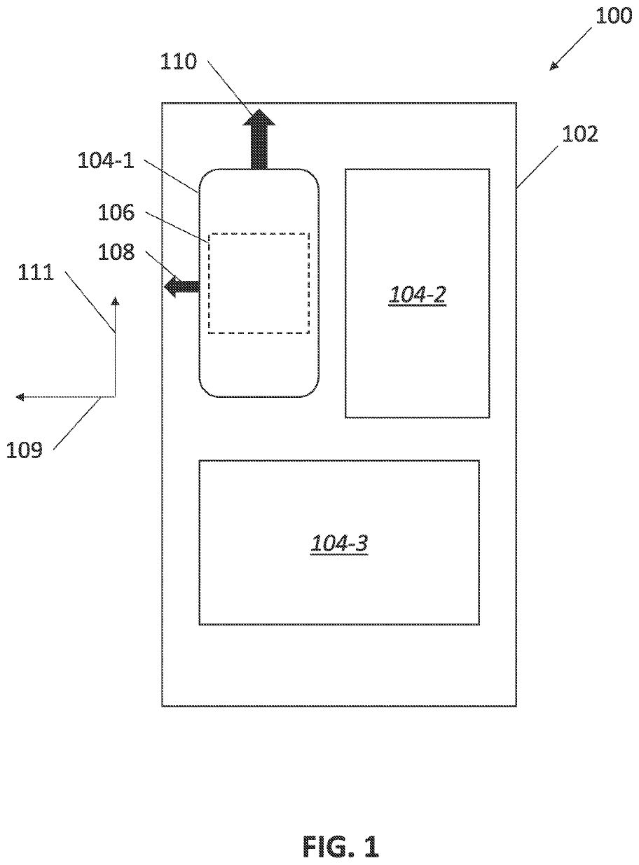

FIG. 1 is a schematic view of a representation of a computing device 100, according to at least one embodiment of the present disclosure. The computing device 100 may include a housing 102. In some embodiments, the housing 102 may be the outer housing of the computing device. In some embodiments, the housing 102 may be a structure within an outer housing, such as a manifold, shelf, support, or other structure within a computing device. In some embodiments, the housing 102 may have a three-dimensional shape, such as a “bucket,” with a base, walls that extend up from the base, and an open top.

The computing device 100 may include one or more computing components (collectively 104). The computing components 104 may be any type of computing component, such as a battery, a processor, a heat distribution device, a fan, a power bus, any other computing component, and combinations thereof. For example, a first computing component 104-1 may be a battery, a second computing component 104-2 may be a processor, and a third computing component 104-3 may be a heat distribution device, such as a vapor chamber and the like.

In some situations, a user or a technician may desire to remove the computing component 104 from the housing. Using a double-sided tape, the user may pull the computing component 104 from the housing. However, conventional double-sided tapes may require a large removal force. This may increase the difficulty of removing the computing device. Furthermore, conventional double-sided tapes may leave a residue behind on the component, the housing, or both. The residue may be difficult to clean off and may make installing a replacement component, or a different component in the same location, difficult.

The computing components 104 may be fastened to the housing 102. In accordance with embodiments of the present disclosure, at least one of the computing components 104 may be fastened to the housing 102 with an anisotropic stretch release tape 106 (shown in dashed lines for ease of illustration). For example, the first computing component 104-1 may be fastened to the housing 102 with the anisotropic stretch release tape 106. Batteries are a commonly replaced item on a computing device, at least in part because, after a certain number of charge cycles, a battery's charge capacity becomes reduced. A user having a reduced capacity battery may desire to replace the battery. Similarly, a user may desire to switch the second computing component 104-2 for a different processor having greater RAM memory, faster speed, lower space requirements, and so forth. A user may desire to switch the third computing component 104-3 for a different heat distribution device or for a different computing component entirely. Easily removable computing components 104 may allow a user to customize his or her computing device 100, thereby improving the user experience.

The removal of a computing component 104 may be described herein with respect the first computing component 104-1. However, it should be understood that the embodiments of the present disclosure may be applicable to any computing component, including the second computing component 104-2 and/or the third computing component 104-3.

The user may apply a removal force to the first computing component 104-1 to remove the first computing component 104-1 from the housing 102. In accordance with embodiments of the present disclosure, the anisotropic stretch release tape 106 may have a different first removal force 108 in a first removal direction 109 than a second removal force 110 in a second removal direction 111. In the embodiment shown, the first removal force 108 may be lower than the second removal force 110, indicated by the relative size of the arrow illustrating the first removal force 108 to the size of the arrow illustrating the second removal force 110.

When a user applies the first removal force 108 in the first removal direction 109, the anisotropic stretch release tape 106 may release from one or both of the housing 102 or the first computing component 104-1. In this manner, the first computing component 104-1 may be removed from the housing 102. However, if the user were to apply a force having the magnitude of the first removal force 108 in the second removal direction 111, the anisotropic stretch release tape 106 may remain connected to both the first computing component 104-1 and the housing 102.

In some embodiments, the first removal force 108 and/or the second removal force 110 may be applied parallel to a plane of the computing component 104 and the housing 102 (e.g., parallel to the plane of the anisotropic stretch release tape 106, or parallel to a plane of a backing of the anisotropic stretch release tape 106). In some embodiments, the first removal force 108 and/or the second removal force 110 may be applied at an angle relative to the plane of the anisotropic stretch release tape 106. In some embodiments, the total removal force may increase based on the out-of-plane angle of the force. However, the component of the removal force in the first removal direction 109 and/or the second removal direction 111 may remain the first removal force 108 and/or the second removal force 110.

In this manner, a different removal force in the first removal direction 109 than the second removal direction 111 may help the user to control in which direction the first computing component 104-1 is removed from the housing 102. This may help the user to reduce or prevent damage to other computing components 104 located in the housing 102. For example, space within the housing 102 is often limited, and computing components 104 may be placed next to each other with little room to spare. Removing a computing component 104 in the wrong direction may cause the computing component 104 to bump, jostle, nudge, or otherwise contact another computing component, potentially damaging either component. By strategically orienting the anisotropic stretch release tape 106, a removal sequence may be developed that instructs a user how to safely remove computing components 104 to reduce or minimize damage to the computing device 100 or computing components 104.

In accordance with embodiments of the present disclosure, the first removal force 108 may be a removal percentage of the second removal force 110 (e.g., the first removal force 108 divided by the second removal force 110). In some embodiments, the removal percentage may be in a range having an upper value, a lower value, or upper and lower values including any of 40%, 50%, 60%, 70%, 80%, or any value therebetween. For example, the removal percentage may be greater than 40%. In another example, the removal percentage may be less than 80%. In yet other examples, the removal percentage may be any value in a range between 40% and 80%. In some embodiments, it may be critical that the removal percentage is less than 50% to allow the user to feel a difference in removal forces, which may help to prevent accidental removal of the first computing component 104-1 in the wrong direction. In some embodiments, the removal percentage may be between 40% and 70%. As an example, in some embodiments, the second removal force 110 may be 15 N and the first removal force may be between 6 N and 8 N, resulting in a removal percentage of 40% and 53%. This may allow for a balance between ease of removal of the first computing component 104-1 and retaining a first removal force that is large enough to withstand shock loading, impact loading, and other sudden loading scenarios.

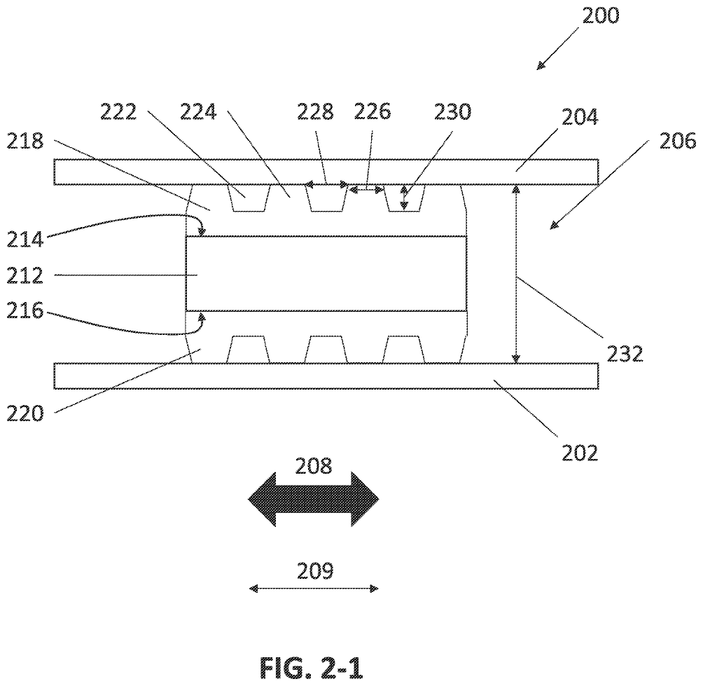

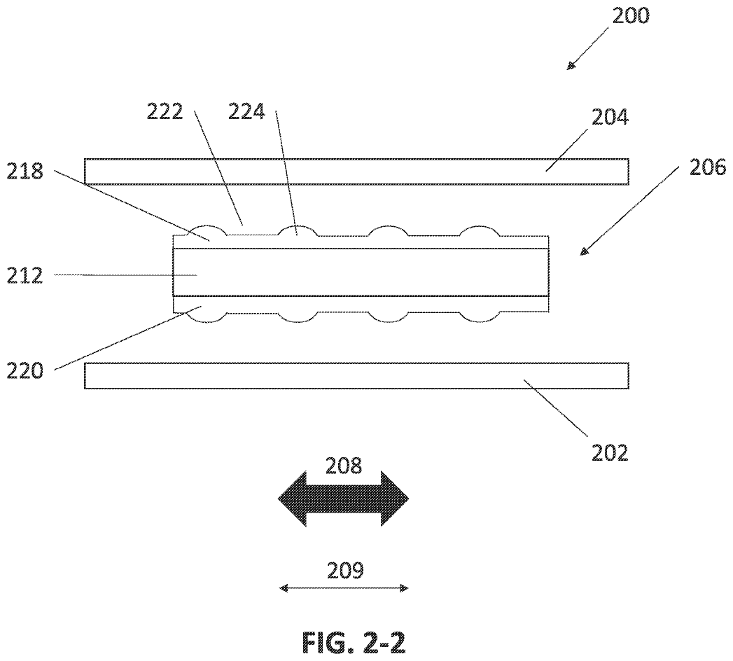

FIG. 2-1 is a representation of a cross-sectional side view of a portion of a computing device 200 in which an anisotropic stretch release tape 206 connects a computing component 204 to a housing 202, according to at least one embodiment of the present disclosure. The anisotropic stretch release tape 206 includes a backing 212 having an upper surface 214 and a lower surface 216. An upper PSA layer 218 may be located on the upper surface 214 and a lower PSA layer 220 may be located on the lower surface 216. The upper PSA layer 218 may be adhered to (e.g., connected to) the computing component 204 and the lower PSA layer 220 may be adhered to the housing 202. In this manner, as may be seen, the anisotropic stretch release tape 206 may connect the computing component 204 to the housing 202.

In the embodiment shown in FIG. 2-1, the upper PSA layer 218 is illustrated as the same as the lower PSA layer 220. However, as will be discussed in further detail herein, it should be understood that the upper PSA layer 218 may have different properties than the lower PSA layer 220. The upper PSA layer 218 includes a plurality of grooves 222 (e.g., valleys, depressions, holes, indentations) in the PSA forming the upper PSA layer 218. The grooves 222 may be formed between consecutive ridges 224 (e.g., peaks, bumps, protrusions). The ridges 224 may be formed from the PSA that makes up the PSA layer 218, and the grooves 222 may not include any PSA material. The ridges 224 may extend parallel or approximately parallel to the grooves 222. For example, in the view shown, the ridges 224 and the grooves 222 may extend into and out of the page.

The ridges 224 have a ridge width 226. The ridge width 226 may be the width of the ridge 224 where the ridge 224 contacts the computing component 204. In some embodiments, the ridge width 226 may be a contact length or the contact width in the first removal direction 209, or the length of contact of an individual ridge with the computing component 204. In some embodiments, the ridge width 226 may be in a range having an upper value, a lower value, or upper and lower values including any of 25 micrometers, 50 micrometers, 75 micrometers, 100 micrometers, 150 micrometers, 200 micrometers, 300 micrometers, 400 micrometers, 500 micrometers, 600 micrometers, 700 micrometers, 800 micrometers, 900 micrometers, 1,000 micrometers, or any value therebetween. For example, the ridge width 226 may be greater than 25 micrometers. In another example, the ridge width 226 may be less than 1,000 micrometers. In yet other examples, the ridge width 226 may be any value in a range between 25 micrometers and 1,000 micrometers. In some embodiments, it may be critical that the ridge width 226 is less than 800 micrometers to increase the difference between the first removal force 208 and the second removal force (e.g., into and out of the page). In some embodiments, it may be critical that the ridge width 226 is less than 800 micrometers to increase the difference between the first removal force 208 and the second removal force.

The grooves 222 have a groove width 228. The groove width 228 may be the distance between two adjacent or consecutive ridges 224. In some embodiments, the groove width 228 may be the distance between two adjacent ridges 224 at the peak of the ridges 224. In some embodiments, the groove width 228 may be the furthest distance between two adjacent ridges 224. In some embodiments, the groove width 228 may be in a range having an upper value, a lower value, or upper and lower values including any of 25 micrometers, 50 micrometers, 75 micrometers, 100 micrometers, 150 micrometers, 200 micrometers, 300 micrometers, 400 micrometers, 500 micrometers, 600 micrometers, 700 micrometers, 800 micrometers, 900 micrometers, 1,000 micrometers, 1,500 micrometers, 2,000 micrometers, or any value therebetween. For example, the groove width 228 may be greater than 25 micrometers. In another example, the groove width 228 may be less than 2,000 micrometers. In yet other examples, the groove width 228 may be any value in a range between 25 micrometers and 2,000 micrometers. In some embodiments, it may be critical that the groove width 228 is less than 800 micrometers to increase the difference between the first removal force 208 and the second removal force. In some embodiments, it may be critical that the groove width 228 is less than 50 micrometers to further increase the difference between the first removal force 208 and the second removal force.

During installation of a computing component using a two-sided tape, air may become entrained in one or both of the layers of the PSA. Entrained air bubbles may reduce the removal force used to remove the computing component. This may lead to unintended or undesired removals. In some embodiments, including the one or more grooves 222 may help to reduce or eliminate bubbles or other sources of entrained air between the PSA layers and the computing device 204 and/or the housing 202. In some embodiments, a larger groove width 228 may help to reduce bubbles or other sources of entrained air that may be produced when connecting the computing component 204 to the housing. This may help to improve the consistency of removal forces between different computing devices.

The grooves 222 have a groove depth 230. The groove depth 230 may be the distance from the top of a ridge 224 to the bottom of the groove 222. In some embodiments, the groove depth 230 may be in a range having an upper value, a lower value, or upper and lower values including any of 25 micrometers, 50 micrometers, 75 micrometers, 100 micrometers, 150 micrometers, 200 micrometers, 300 micrometers, 400 micrometers, 500 micrometers, or any value therebetween. For example, the groove depth 230 may be greater than 25 micrometers. In another example, the groove depth 230 may be less than 500 micrometers. In yet other examples, the groove depth 230 may be any value in a range between 25 micrometers and 500 micrometers. In some embodiments, it may be critical that the groove depth 230 is less than 200 micrometers to increase the difference between the first removal force 208 and the second removal force. In some embodiments, it may be critical that the groove depth 230 is between 50 micrometers and 200 micrometers to increase the difference between the first removal force 208 and the second removal force.

In accordance with embodiments of the present disclosure, the anisotropic stretch release tape 206 may have a first removal force 208 in a first removal direction 209. As may be seen, the first removal force 208 and/or the first removal direction 209 may be transverse (e.g., not parallel) or perpendicular to the ridges 224 and grooves 222. Put another way, the first removal force 208 and/or the first removal direction 209 may be oriented transverse or perpendicular to the ridges 224. Note that the first removal force 208 and/or the first removal direction 209 may be “positive” (e.g., directed to the right) or “negative” (e.g., directed to the left). For example, when the first removal force 208 is applied to the computing device 200, the computing component 204 may move in the positive first removal direction (e.g., to the right) and the housing 202 may move in the negative first removal direction (e.g., to the left), or vice versa. The second removal force (e.g., the second removal force 110 of FIG. 1) in the second removal direction (e.g., the second removal direction 111 of FIG. 1) may be applied into and out of the page in FIG. 2-1.

The backing 212 may be formed from a deformable material. In some embodiments, the backing 212 may be formed from an elastically deformable material (e.g., the backing 212 may be an elastic backing). An elastic backing 212 may allow the backing 212 to return to a neutral shape or position after deformation. In some embodiments, an elastic backing 212 may allow the anisotropic stretch release tape 206 to be reused after stretching the backing 212. In some embodiments, the backing 212 may be formed from a plastically deformable material. A plastically deformable backing 212 may not return to a neutral shape or position after deformation. In some embodiments, a plastically deformable backing 212 may reduce the adhesive properties of the upper PSA layer 218 and/or the lower PSA layer 220 after removal, thereby making the anisotropic stretch release tape 206 to be completely removed with little or no residue deposited on the computing component 204 and/or the housing 202. The backing 212 may have a fracture or breaking strength. The breaking strength may be the amount of force that, when applied to the backing 212, may cause the backing 212 to break, tear, fracture, or otherwise split into multiple pieces.

When the first removal force 208 is applied to the computing component 204 and/or the housing 202, a shear force may be applied to the anisotropic stretch release tape 206. In some embodiments, the shear force may cause at least one of the backing 212 to deform, the first PSA layer 218 to deform, or the second PSA layer 220 to deform. As the backing 212 deforms, the backing 212 may increase in length in the first removal direction. Increasing the length of the backing 212 in the first removal direction may cause the ridges 224 of the first PSA layer 218 to separate from the computing component 204, which may cause the first PSA layer 218 to disconnect or separate from the computing component 204.

The first removal force 208 may be based, at least in part, on the amount of surface area or contact area of the first PSA layer 218 in contact with the computing component as the backing 212 stretches. As may be understood, the surface area of the first PSA layer 218 may be based, at least in part, on the ridge width 226. In some embodiments, the backing 212 may deform underneath one of the ridges 224. As the backing 212 deforms, the PSA layer 218 may stretch or spread with the backing 212, which may cause the ridge 224 to stretch in the first removal direction 209 and separate from the computing device 204. Put another way, the ridge 224 may stretch and separate from the computing device 204 as a result of the elongation or stretching of the backing 212.

In some embodiments, the first removal force 208 may further be based, at least in part, on the groove width 228. A larger groove width 228 may result in fewer ridges 224 that are in contact with the computing component 204. Fewer ridges 224 may result in a smaller amount of surface area to be separated from the computing component 204 when the computing component 204 is removed from the housing 202.

Applying a force in the second removal direction (e.g., in and out of the page) may urge the backing 212 to deform and stretch in the second removal direction. The second removal direction may be oriented parallel or approximately parallel to the ridges 224 and grooves 222. To deform and separate the first PSA layer 218 from the computing device 204, the backing 212 may stretch the first PSA layer 218 along the length of the ridge 224. The length of the ridge 224 may be larger, or significantly larger (e.g., greater than 10 times, greater than 100 times, greater than 1,000 times) than the ridge width 226. Furthermore, the length of the ridge 224 may not be separated by, or may be separated by at long lengths, a spacing or a groove. In this manner, the second removal direction being oriented parallel or approximately parallel to the ridges 224 and grooves 222 may increase the second removal force 208. The first removal direction may be transverse or perpendicular to the second removal direction. As discussed herein, when removing the anisotropic stretch release tape 206 in the first removal direction, the area of adhesive to remove may be less (e.g., the width of the ridge 224), thereby reducing the first removal force 208. In this manner, the second removal force may be greater than the first removal force 208.

The anisotropic stretch release tape 206 has a tape thickness 232. The tape thickness 232 may be the total combined thickness of the anisotropic stretch release tape 206, including the upper PSA layer 218, the backing 212, and the lower PSA layer 220. In some embodiments, the tape thickness 232 may be in a range having an upper value, a lower value, or upper and lower values including any of 80 micrometers, 100 micrometers, 150 micrometers, 200 micrometers, 300 micrometers, 400 micrometers, 500 micrometers, 600 micrometers, 700 micrometers, 800 micrometers, 900 micrometers, 1,000 micrometers, 1,100 micrometers, 1,200 micrometers, 1,300 micrometers, 1,400 micrometers, or any value therebetween. For example, the tape thickness 232 may be greater than 80 micrometers. In another example, the tape thickness 232 may be less than 1400 micrometers. In yet other examples, the tape thickness 232 may be any value in a range between 80 micrometers and 1400 micrometers. In some embodiments, it may be critical that the tape thickness 232 is less than 100 micrometers to reduce the space the anisotropic stretch release tape 206 occupies in a computing device. In some embodiments, the tape thickness 232 may be different for different applications. For example, for a computing component 204 that is a battery, the tape thickness may be between 80 micrometers and 1,400 micrometers. In some embodiments, for the battery computing component 204, the tape thickness 232 may be between 80 micrometers and 250 micrometers. In some embodiments, for a touch display computing component 204, the tape thickness 232 may be between 500 micrometers and 1,000 micrometers. In this manner, a designer may design the anisotropic stretch release tape 206 to have a tape thickness 232 that is tailored to a particular computing component 204, and be designed based, at least in part, on several elements, including the desired removal force, the desired device thickness, and so forth. In some embodiments, the tape thickness 232 may be reduced as a result of the gravure roller preparation of the anisotropic stretch release tape.

In FIG. 2-2, the anisotropic stretch release tape 206 has separated from both the computing component 204 and the housing 202. As may be seen, after the first removal force 208 has been applied, the backing 212 has stretched. As a result of the backing stretching 212, the upper PSA layer 218 and the lower PSA layer 220 have stretched. As may be seen in a comparison between FIG. 2-1 and FIG. 2-2, stretching the backing 212, the upper PSA layer 218, and the lower PSA layer 220 may have resulted in the deformation of the ridges 224 and/or elongation of the grooves 222. This deformation and/or elongation may have helped to release the upper PSA layer 218 from the computing component 204.

In some embodiments the deformation and/or elongation of the grooves 222 and/or the ridges 224 may help to reduce or eliminate the amount of residue left on a contact surface of the computing component 204 and/or the housing 202. Because the deformation gently releases the PSA forming the upper PSA layer 218 and/or the lower PSA layer 220, the majority or an entirety of the PSA forming the upper PSA layer 218 and/or the lower PSA layer 220 may stay connected or adhered to the backing 212. Residue may be difficult to remove, add volume to the computing device 200, and prevent a replacement computing component 204 from properly adhering to the housing. By reducing or eliminating the amount of residue, replacement of computing components may be faster, easier, and/or more efficient.

In some embodiments, the first removal force 208 may be less than the breaking or fracture strength of the backing 212. When the first removal force 208 is applied to the computing device 200 shown, anisotropic stretch release tape 206 may release from the computing component 204 and/or the housing 202 without the backing 212 breaking. This may help to reduce or prevent any of the backing 212 from remaining on a surface of the computing component 204 and/or the housing 202.

In the embodiment shown in FIG. 2-1 and FIG. 2-2, the properties upper PSA layer 218 and the lower PSA layer 220 may be the same. For example, the upper PSA layer 218 and the lower PSA layer 220 may be the same groove width 228, the same ridge width 226, and the same groove depth 230. This may result in the upper PSA layer 218 having the same or approximately the same first removal force 208 as the lower PSA layer 218. In some embodiments, as discussed herein, the upper PSA layer 218 may have one or more different properties as the lower PSA layer 220. Put another way, the upper PSA layer 218 may have a first set of properties and the lower PSA layer 220 may have a second set of properties, and at least one of the first set of properties may be different than a corresponding property from the second set properties. In some embodiments, different properties between the upper PSA layer 218 and the lower PSA layer 220 may result in a different first removal force 208 on the upper PSA layer 218 compared to the lower PSA layer 220. In some embodiments, the set of properties may include at least one of groove depth, groove width, groove orientation, PSA thickness, PSA type, and combinations thereof.

In accordance with embodiments of the present disclosure, a different first removal force 208 between the upper PSA layer 218 and the lower PSA layer 220 may result in the layer having the lower removal force being disconnected from the surface to which it is adhered, and the layer having the higher removal force remaining adhered to its surface. This may allow the designer of a computing device to determine to which element the anisotropic stretch release tape 206 may remain adhered. This may reduce the amount of cleaning of residue and anisotropic stretch release tape 206 remaining stuck to an undesired surface.

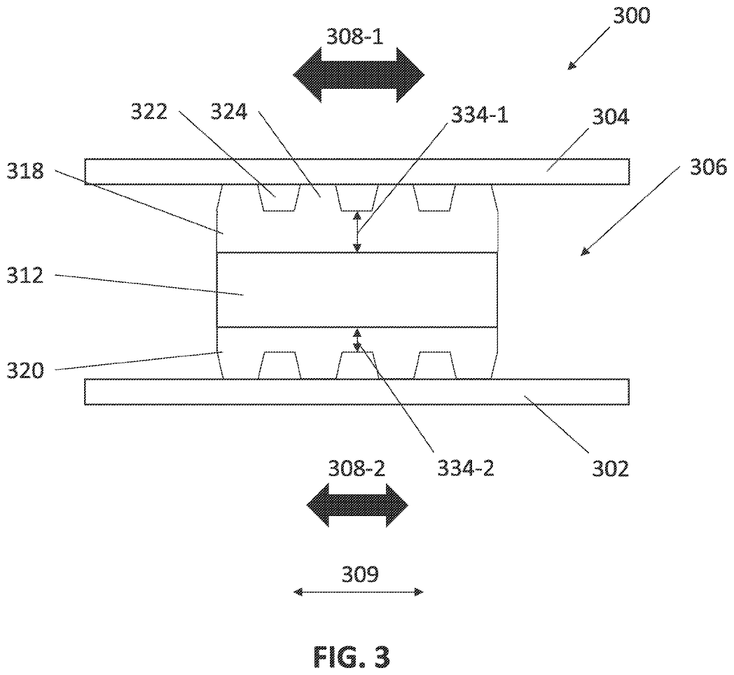

For example, in FIG. 3, an upper PSA thickness 334-1 of the upper PSA layer 318 may be greater than a lower PSA thickness 334-2 of the lower PSA layer 320. In some embodiments, the PSA thickness (collectively 334) may be measured from the backing 312 to the bottom of a channel 322. In some embodiments, the PSA thickness 334 may be measured from the backing 312 to the top of a ridge 324. In accordance with embodiments of the present disclosure, a larger PSA thickness 334 may result in a larger first removal force (collectively 308), and a smaller PSA thickness 334 may result in a smaller first removal force 308.

In the embodiment shown in FIG. 3, the upper PSA thickness 334-1 is greater than the lower PSA thickness 334-2. This may result in an upper first removal force 308-1 that is greater than a lower first removal force 308-2. As a first removal force 308 is applied to the computing device 300, when the removal force reaches the magnitude of the lower first removal force 308-2, the lower PSA layer 320 may separate from the housing 302. Because the lower first removal force 308-2 is less than the upper first removal force 308-1, the upper PSA layer 318 may remain adhered to the computing component 304. In this manner, the computing component 304 may be removed from the housing 302 without leaving any residue or portion of the backing 312 on the housing 302.

In some embodiments, the lower first removal force 308-2 may be a layer removal percentage of the upper first removal force 308-1 (e.g., the magnitude of the lower first removal force 308-2 divided by the magnitude of the upper first removal force 308-1). In some embodiments, the layer removal percentage may be in a range having an upper value, a lower value, or upper and lower values including any of 40%, 50%, 60%, 70%, 80%, or any value therebetween. For example, the layer removal percentage may be greater than 40%. In another example, the layer removal percentage may be less than 80%. In yet other examples, the layer removal percentage may be any value in a range between 40% and 80%. In some embodiments, it may be critical that the layer removal percentage is less than 50% to remove the lower PSA layer 320 from the housing 302 before the upper PSA layer 318 is removed from the computing component. This may allow for a balance between ease of removal of the first computing component 104-1 and retaining a first removal force that is large enough to withstand shock loading, impact loading, and other sudden loading scenarios.

In some embodiments, both the upper PSA layer 318 and the lower PSA layer 320 may be anisotropic. The upper PSA 318 layer may have an upper first removal force 308-1 in a first removal 309 that is greater than an upper second removal force in a second direction (e.g., into and out of the page). The lower PSA layer 320 may have a lower first removal force 308-2 in the first removal 309 that is greater than the lower second removal first in the second direction. After the computing component 304 and the anisotropic stretch release tape 306 are removed from the housing 302, the anisotropic stretch release tape 306 may be removed from the computing component 304 by applying the upper first removal force 308-1 to the anisotropic stretch release tape 306.

In some embodiments, based on the set of properties of the upper PSA layer 318 and the lower PSA layer 320, the upper second removal force may be the same as the lower second removal force. In some embodiments, the upper second removal force may be different than the lower second removal force. For example, the upper second removal force may be greater than the lower second removal force. This may help to prevent the inadvertent removal of the computing component 304 from the housing 302.

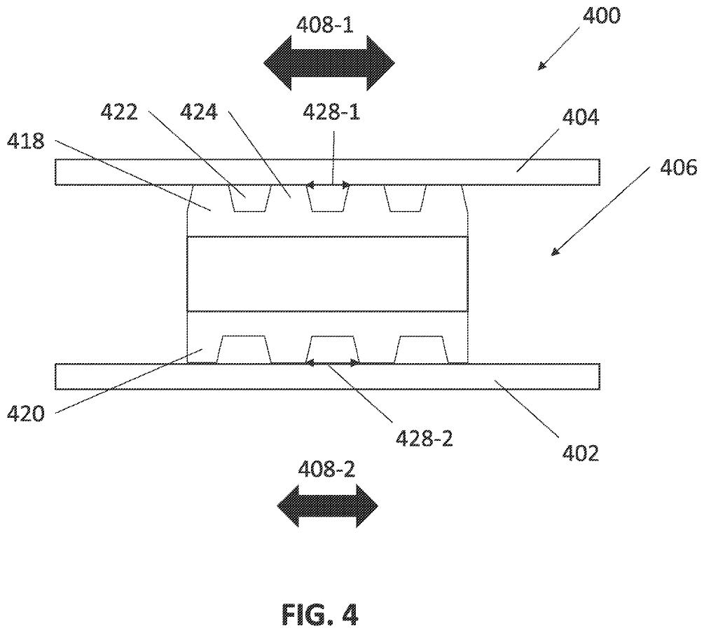

FIG. 4 is a representation of a computing device 400 having a computing component 404 connected to a housing 402 with an anisotropic stretch release tape 406, according to at least one embodiment of the present disclosure. The anisotropic stretch release tape 406 may include an upper PSA layer 418 having an upper groove width 428-1 of grooves 422 between ridges 424 that is less than a lower groove width 428-2 of a lower PSA layer 420. As discussed herein, the groove width (collectively 428) may be inversely related to the first removal force (collectively 408), with a larger groove width 428 resulting in a lower first removal force 408. In some embodiments, the lower groove width 428-2 being less than the upper groove width 428-2 may result in a lower first removal force 408-2 that is less than an upper first removal force 408-1.

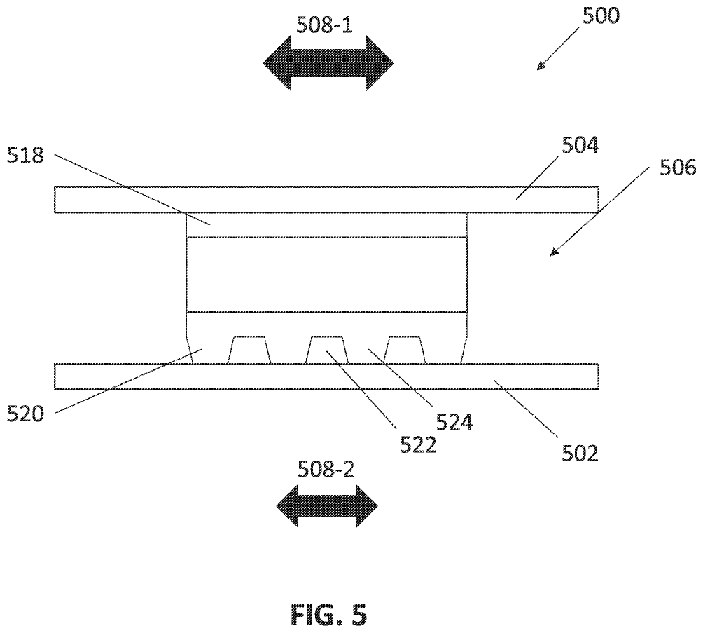

FIG. 5 is a representation of a computing device 500 having a computing component 504 connected to a housing 502 with an anisotropic stretch release tape 506, according to at least one embodiment of the present disclosure. The anisotropic stretch release tape 506 may include a lower PSA layer 520 that includes a plurality of ridges 524 and grooves 522. The upper PSA layer 518 may not include any ridges 524 or grooves 522. This may increase the surface area of the upper PSA layer 518 in contact with the computing device 504, thereby increasing the upper first removal force 508-1 relative to the lower first removal force 508-2. Thus, when the lower first removal force 508-2 is applied to the computing system, the lower PSA layer 520 may release from the housing 502 before the upper PSA layer 518 releases from the computing component 604.

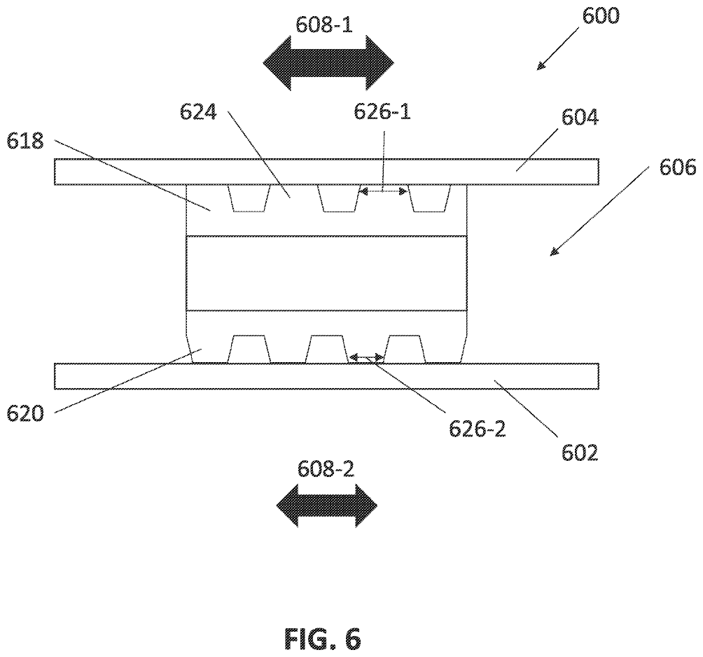

FIG. 6 is a representation of a computing device 600 having a computing component 604 connected to a housing 602 with an anisotropic stretch release tape 606, according to at least one embodiment of the present disclosure. The anisotropic stretch release tape 606 may include a lower PSA layer 620 having an upper ridge width 626-1 of a ridge 624 that is larger than a lower ridge width 626-2. The larger upper ridge width 626-1 may increase the surface area of the upper PSA layer 618 adhered to the housing component 604. This may, in turn, increase the upper first removal force 608-1 relative to the lower first removal force 608-2. Thus, when the lower first removal force 608-2 is applied to the computing device 600, the lower PSA layer 620 may release from the housing 602 before the upper PSA layer 618 releases from the computing component 604.

In some embodiments, any other property of the upper PSA layer 618 may be different from a corresponding property of the lower PSA layer 620. For example, the lower PSA layer 620 may have a larger groove depth (e.g., groove depth 230 of FIG. 2) may be different than the groove depth of the upper PSA layer 618, thereby reducing the upper first removal force. In some embodiments, the orientation of the grooves (e.g., the groove direction) and ridges may vary between the upper PSA layer and the lower PSA layer. This may change the direction of the applied first removal force or second removal force. Changing the direction of the grooves and ridges may allow a computing system designer to designate a direction to apply the first removal force. If the first removal force is applied in a first removal, the anisotropic stretch release tape may release from the housing and remain adhered to the computing component, if the first removal force is applied in a second direction, the anisotropic stretch release tape may release from the computing component and remain adhered to the housing. This may allow the user to determine to which surface the anisotropic stretch release tape may remain adhered, thereby increasing the versatility of computing component replacement.

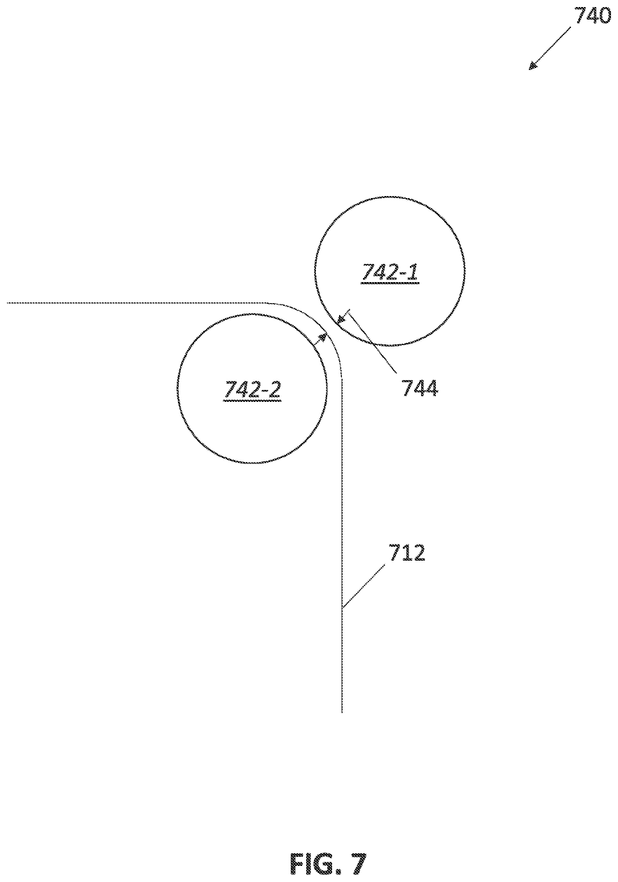

FIG. 7 is a representation of a manufacturing system 700 for an anisotropic stretch release tape, according to at least one embodiment of the present disclosure. The manufacturing system 700 may utilize a gravure roller system to apply a PSA to a backing 712 of the anisotropic stretch release tape. A gravure roller (collectively 742) may be a cylinder that includes a plurality of surface features, such as holes, grooves, divots, detents, depressions, and the like. The surface features may receive wet PSA, such as from a PSA applicator, and apply the wet PSA to the backing 712.

In some embodiments, the manufacturing system may include a first gravure roller 742-1 and a second gravure roller 742-2. The first gravure roller 742-1 may apply or deposit a first layer of PSA to a first side of the backing 712 and the second gravure roller 742-2 may apply or deposit a second layer of PSA to a second side of the backing 712. The texture or structure of the PSA layers may be based, at least in part, on the particular surface features of the gravure roller. For example, the surface features may impart grooves and ridges on the PSA layers. By changing the size, shape, depth, or other properties of the surface features of the gravure rollers 742, the size, shape, and other properties of the grooves and ridges of the PSA layers may be modified.

In some embodiments, the gravure rollers 742 may be separated from the backing 712 with a roller separation 744. In some embodiments, the thickness of the PSA layer may be based, at least in part, on the roller separation 744. For example, a larger roller separation 744 may result in a larger PSA layer thickness and a smaller roller separation 744 may result in a smaller PSA layer thickness. In this manner, by changing the surface features of the gravure rollers 742 and/or the roller separation 744, the set of properties for the PSA layers may be tailored to a particular purpose.

In some embodiments, a gravure roller 742 manufacturing system 740 may allow for a decreased tape thickness (e.g., the tape thickness 232 of FIG. 2-1). Conventionally, features of a PSA layer on a double-sided tape may be milled, ground, or otherwise mechanically formed. This may limit the total thickness of the double sided tape. In accordance with embodiments of the present disclosure, the gravure roller 742 manufacturing system 740 may deposit the PSA layer with the grooves and ridges without any additional manufacturing. This may allow for a reduced tape thickness. As discussed herein, in some embodiments, the tape thickness may be less than 1,400 micrometers, less than 500 micrometers, less than 100 micrometers, or any value therebetween. In some embodiments, a reduced tape thickness may allow for thinner computing devices and/or room for more and/or larger computing components in a computing device.

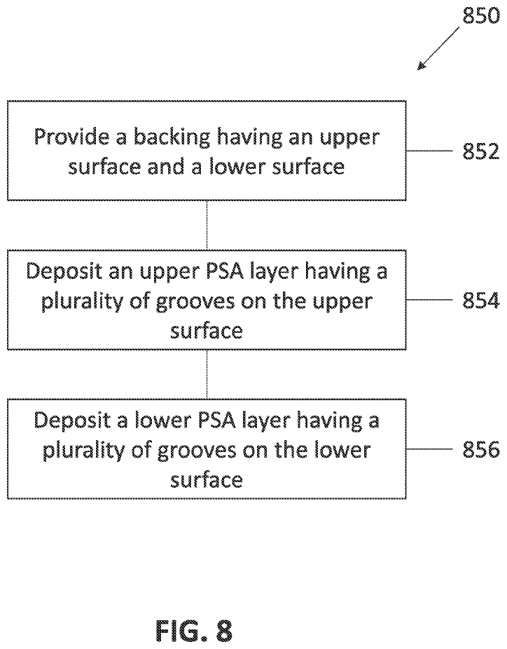

FIG. 8 is a flowchart of a method 850 for manufacturing a computing system, according to at least one embodiment of the present disclosure. The method 850 may be performed by the manufacturing system 740 of FIG. 7. Put another way, the manufacturing system 740 of FIG. 7 may implement the method 850.

The method 850 may include providing a backing having an upper surface and a lower surface at 852. The backing may be a deformable backing. In some embodiments, the backing may be elastically deformable or plastically deformable. A first gravure roller may deposit a PSA in an upper PSA layer at 854. The first gravure roller may include a plurality of surface features. When a PSA is applied to the gravure roller, the gravure roller may then deposit the PSA on the backing. The PSA may be deposited with one or more grooves or ridges, based, at least in part, on the surface features of the gravure roller.

The method 850 may further include depositing PSA in a lower PSA layer at 856. The lower PSA layer may be deposited using a second gravure roller having a plurality of surface features, which may result in ridges and grooves on the lower PSA layer. In some embodiments, the first gravure roller may have the same set of surface features as the second gravure roller. This may result in an upper PSA layer that is the same as the lower PSA layer. In some embodiments, the first gravure roller may have a different set of surface features as the second gravure roller. This may result in an upper PSA layer that has at least one property that is different from the lower PSA layer.

In some embodiments, the first gravure roller may deposit the upper PSA layer on the backing with a first roller separation that is the same as a second roller separation from the second gravure roller. This may result in the upper PSA layer having the same thickness as the lower PSA layer. In some embodiments, the first roller separation may be different from the second roller separation. This may result in the upper PSA layer having a different thickness as the lower PSA layer.

Following are sections in accordance with the present disclosure:
A1. A stretch release tape, comprising:
   a backing including an upper surface and a lower surface, wherein the backing is deformable;
   a first pressure sensitive adhesive (PSA) layer connected to the upper surface; and
   a second PSA layer connected to the lower surface, wherein a first removal force for the stretch release tape in a first direction is at least 50 percent less than a second removal force in a second direction.
A2. The tape of section A1, wherein the first PSA layer has an upper first removal force in the first direction that is less than an upper second removal force in the second direction and the second PSA layer has a lower first removal force in the first direction that is less than a lower second removal force in the second direction.
A3. The tape of section A2, wherein the upper first removal force is greater than the lower first removal force.
A4. The tape of section A2 or A3, wherein the first PSA layer has a first set of properties and the second PSA layer has a second set of properties, and wherein the first set of properties and the second set of properties include at least one of a groove depth, a groove width, a groove orientation, PSA thickness, or PSA type, and wherein at least one of the first set of properties is different than a corresponding property from the second set of properties.
A5. The tape of section A4, wherein the at least one of the first set of properties that is different than the corresponding property is the groove width.
A6. The tape of section A4 or A5, wherein the at least one of the first set of properties that is different than the corresponding property is the PSA thickness.
A7. The tape of any of sections A2-A6, wherein the first PSA layer includes a plurality of grooves, and wherein the plurality of grooves are oriented approximately parallel to the second removal force.
A8. The tape of any of sections A1-A7, wherein the first removal force and the second removal force are oriented in a direction parallel to a plane of the backing.
A9. The tape of any of sections A1-A8, wherein the backing is plastically deformable.
B1. A stretch release tape, comprising:
   a backing including an upper surface and a lower surface, wherein the backing is elastically deformable;
   a first pressure sensitive adhesive (PSA) layer connected to the upper surface, wherein the first PSA layer includes a plurality of grooves having a groove width of between 25 micrometers and 2,000 micrometers; and
   a second PSA layer connected to the lower surface.
B2. The tape of section B1, wherein the first PSA layer, and the second PSA layer have a tape thickness of between 15 micrometers and 200 micrometers.
B3. The tape of section B1 or B2, wherein the backing has a thickness of between 50 micrometers and 1,000 micrometers.
B4. The tape of any of sections B1-B3, wherein a groove depth is between 25 micrometers and 500 micrometers.
B5. The tape of any of sections B1-B4, wherein a contact width of the plurality of grooves is between 25 micrometers and 1,000 micrometers.
B6. The tape of any of sections B1-B5, wherein the second PSA layer does not include any ridges or grooves.
C1. A computing system, comprising:
   a computing component configured to be connected to a housing of a computing device;
   a stretch release tape, the stretch release tape including:
      a backing having an upper surface and a lower surface, wherein the backing is elastically deformable;
      an upper pressure sensitive adhesive (PSA) layer connected to the upper surface of the backing and the computing component; and
      a lower PSA layer connected to the lower surface, wherein the lower PSA layer is configured to be connected to the housing, wherein the lower PSA layer has a lower first removal force in a first direction that is at least 50% less than a lower second removal force in a second direction.
C2. The system of section C1, wherein the upper PSA layer has an upper first removal force in the first direction and an upper second removal force in the second direction, and wherein the upper second removal force is greater than the lower second removal force.
C3. The system of section C1 or C2, wherein, when the stretch release tape is removed from the computing device, the stretch release tape does not leave a residue.
C4. The system of any of sections C1-C3, wherein the stretch release tape has a total thickness of between 80 micrometers and 1,400 micrometers.
D1. A method for manufacturing a computing component to a housing of a computing device, comprising:
   providing a backing having an upper surface and a lower surface;
   depositing an upper PSA layer on the upper surface, the upper PSA layer having a plurality of grooves; and
   depositing a lower PSA layer on the lower surface, the lower PSA layer having a plurality of grooves,
D2. The method of section D1, wherein depositing the upper PSA layer includes depositing the upper PSA layer using a gravure roller.
D3. The method of section D1 or D2, wherein depositing the lower PSA layer includes depositing the lower PSA layer using a gravure roller.
D4. The method of any of sections D1-D3, further comprising: connecting the upper PSA layer to the computing component; and connecting the lower PSA layer to the housing.
D5. The method of section D4, wherein connecting the upper PSA layer to the computing component includes connecting the upper PSA layer without entrained air in the upper PSA layer.
D6. The method of section D4 or D5, wherein connecting the lower PSA layer to the computing component includes connecting the lower PSA layer without entrained air in the upper PSA layer.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A stretch release tape, comprising:
a backing including an upper surface and a lower surface, wherein the backing is deformable;
a first pressure sensitive adhesive (PSA) layer connected to the upper surface; and
a second PSA layer connected to the lower surface, wherein a first removal force for the stretch release tape in a first direction is at least 50 percent less than a second removal force in a second direction.

2. The tape of claim 1, wherein the first PSA layer has an upper first removal force in the first direction that is less than an upper second removal force in the second direction and the second PSA layer has a lower first removal force in the first direction that is less than a lower second removal force in the second direction.

3. The tape of claim 2, wherein the upper first removal force is greater than the lower first removal force.

4. The tape of claim 2, wherein the first PSA layer has a first set of properties and the second PSA layer has a second set of properties, and wherein the first set of properties and the second set of properties include at least one of a groove depth, a groove width, a groove orientation, PSA thickness, or PSA type, and wherein at least one of the first set of properties is different than a corresponding property from the second set of properties.

5. The tape of claim 4, wherein the at least one of the first set of properties that is different than the corresponding property is the groove width.

6. The tape of claim 4, wherein the at least one of the first set of properties that is different than the corresponding property is the PSA thickness.

7. The tape of claim 2, wherein the first PSA layer includes a plurality of grooves, and wherein the plurality of grooves are oriented approximately parallel to the second removal force.

8. The tape of claim 1, wherein the first removal force and the second removal force are oriented in a direction parallel to a plane of the backing.

9. The tape of claim 1, wherein the backing is plastically deformable.

10. A stretch release tape, comprising:
a backing including an upper surface and a lower surface, wherein the backing is elastically deformable;
a first pressure sensitive adhesive (PSA) layer connected to the upper surface, wherein the first PSA layer includes a plurality of grooves having a groove width of between 25 micrometers and 2,000 micrometers; and
a second PSA layer connected to the lower surface.

11. The tape of claim 10, wherein the first PSA layer, and the second PSA layer have a tape thickness of between 15 micrometers and 200 micrometers.

12. The tape of claim 10, wherein the backing has a thickness of between 50 micrometers and 1,000 micrometers.

13. The tape of claim 10, wherein a groove depth is between 25 micrometers and 500 micrometers.

14. The tape of claim 10, wherein a contact width of the plurality of grooves is between 25 micrometers and 1,000 micrometers.

15. The tape of claim 10, wherein the second PSA layer does not include any ridges or grooves.

16. A computing system, comprising:
a computing component configured to be connected to a housing of a computing device;
a stretch release tape, the stretch release tape including:
a backing having an upper surface and a lower surface, wherein the backing is elastically deformable;
an upper pressure sensitive adhesive (PSA) layer connected to the upper surface of the backing and the computing component; and
a lower PSA layer connected to the lower surface, wherein the lower PSA layer is configured to be connected to the housing, wherein the lower PSA layer has a lower first removal force in a first direction that is at least 50% less than a lower second removal force in a second direction.

17. The system of claim 16, wherein the upper PSA layer has an upper first removal force in the first direction and an upper second removal force in the second direction, and wherein the upper second removal force is greater than the lower second removal force.

18. The system of claim 16, wherein, when the stretch release tape is removed from the computing device, the stretch release tape does not leave a residue.

19. The system of claim 16, wherein the stretch release tape has a total thickness of between 80 micrometers and 1,400 micrometers.
